(19) United States
(12) Patent Application Publication
(10) Pub. No.: US 2008/0005654 A1
(43) Pub. Date: Jan. 3, 2008

(54) Apparatus and method for multimedia product distribution

(75) Inventor: James K. Devericks, Lantana, FL (US)

Correspondence Address: MCHALE & SLAVIN, P.A., 2855 PGA BLVD, PALM BEACH GARDENS, FL, 33410, US

(73) Assignee: Titan Global Holdings, Inc.

(21) Appl. No.: 11/480,766

(22) Filed: Jun. 30, 2006

(51) Int. Cl. G06F 15/00

(52) U.S. Cl. 715/500.1

(57) ABSTRACT

A system and method for receiving, analyzing and distribution of digital media, such as music, which comprises providing a database constructed and arranged to receive digital media, providing a record division for reviewing the digital media, categorizing the digital media into separate artist management groups, providing artist management whereby selected artists are provided with training and promotion, providing a publishing division whereby a portion said selected artists are provided with a way to distribute their works, distributing the digital media from the database to authorized individuals. One embodiment of this system operates completely online over the Internet.

### FIELD OF THE INVENTION

The invention relates to a method of doing business in the entertainment industry and the systems which enable this method.

### BACKGROUND OF THE INVENTION

There has always been a demand for entertainment products. The Egyptians and Greeks invented various forms of entertainment for the royalty. Later, entertainment was provided for those persons with leisure time. Eventually most everyone now has leisure time to enjoy entertainment. This led to the development of a business or industry to provide this entertainment to the masses. In the early to mid 1900's large movie studios controlled the discovery, development and production of movies and the actors and actresses who performed in these movies. The music industry had various companies which controlled the discovery, development and distribution of recorded music and live musical performances. Later the introduction of television led to many industries which manage and control the content of what is broadcast on television, both public and cable.

Recent advances in technology have enabled new methods of distribution of entertainment products. The MP3 players and digital music compression technology have enabled individuals to download their favorite music from various websites. The development of cable television has enabled the broadcast of a much wider variety of programs than those available on broadcast television. The development of DVDs has enabled almost everyone to enjoy movies in the comfort of their home without having to “go to the movies.” The development of streaming video has enabled most video products to be sent over the Internet and other carriers.

The following four technological breakthroughs have led to a major change with respect to the distribution of digital media products.

1) The development of audio compression algorithms, allowing music files to be digitally stored at a fraction of their original storage space without significant loss of music quality.

2) The increase of the population utilizing the Internet, especially with high-speed or broadband Internet connections.

3) The development of peer-to-peer file sharing services.

4) The decreasing cost per megabyte of storage (memory) and increasing capacity of storage devices.

Up until now there have been areas of the entertainment industry which have provided for the discovery of new artists; the development of new artists; the promotion of established and new artists; the production and delivery of entertainment in various forms for example, audio, video, television, etc. No one has tried to encompass all of these under one umbrella.

### DESCRIPTION OF THE PRIOR ART

U.S. Pat. No. 5,237,157 discloses a system for user interactive multimedia based on point-of-preview. In particular, interactive music sampling kiosks for the retail music industry. The consumer takes any musical selection in the store to a kiosk and scans it. They then scan their user/subscriber card and an album cover of their selection appears on the touch screen monitor. A list of the songs appears next and the user can make a selection and hear a 30 second portion of the song through a pair of headphones. If the consumer approves they can then purchase the album in the retail portion of the store. While this system allows the consumer to preview individual songs, it does not permit the consumer to purchase individual songs. In addition it does not permit the consumer to download individual songs into their digital music devices. Further, it does not provide the consumer with an opportunity to listen to and purchase a new song on day of its release.

### SUMMARY OF THE INVENTION

A method and system are provided for the discovery of new talent in the entertainment industry, development of the talent and promotion of the talent.

Accordingly, it is an objective of the instant invention to provide a single system for the discovery, development, promotion and distribution of talent in the entertainment industry.

It is a further objective of the instant invention to provide system whereby artists may submit their works in digital form for review and distribution.

It is yet another objective of the instant invention to provide a unique online portal for the distribution of entertainment material and receipt of entertainment material.

It is a still further objective of the invention

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a diagram of a business model for Titan Global Entertainment; and

FIG. 2 is a diagram of the process of receipt, processing and distribution of entertainment products.

### DETAILED DESCRIPTION OF THE INVENTION

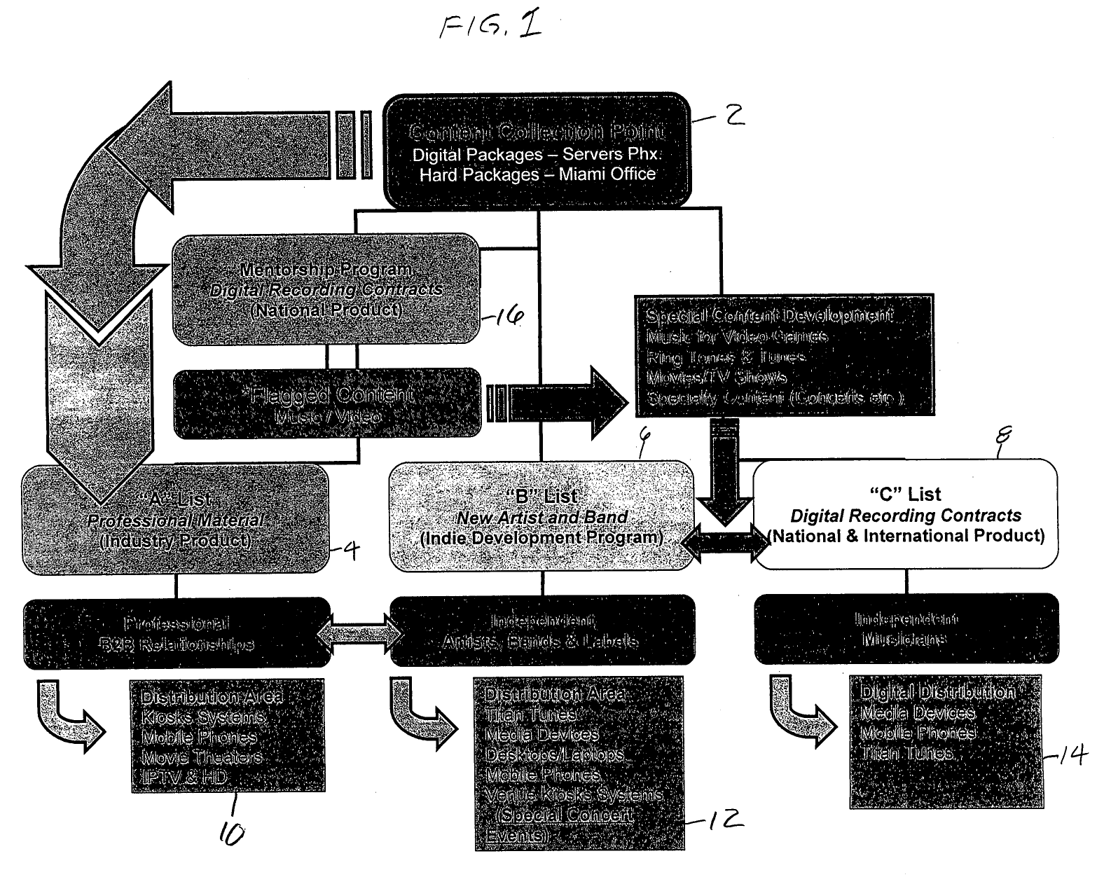

Referring to FIG. 1 of the drawings, there is a flow chart of the business model of the instant invention. Entertainment contents are introduced into the system, in this case Titan Global Entertainment, at 2. There are two major methods of introduction. The first is the conventional method wherein a song, video, etc., on a medium, is physically sent or brought to the collection point for new content material. These are known as “hard packages.” In addition, a digital version of the material can be sent over the Internet to a server where it will downloaded and reviewed. This enables anyone with a connection to the Internet, regardless of their location, to submit material for consideration to the collection point of new material of the instant invention. The digital submission could also include and electronic press kit (EPK).

At this point, in the record division, a determination is made and the material submitted is placed on the “A” list (4), the “B” list (6) or the “C” list (8). The “A” list consists of professional material submitted by established artists. These are normally artist affiliated with recording labels, both major and indie (independent). They normally would have a contract with a record label and are being professionally managed by the recording label company. Their submissions are complete finished products awaiting distribution. Titan Global Entertainment would normally have already established a working relationship with these companies. Submissions on behalf of these artists could be received from producers or production companies, entertainment attorneys, publishers, or the recording label companies. Publishers would be submitting literary works from their clients. A minimum amount of work and effort on behalf of Titan would be required to distribute these artists' works and/or merchandise. These artists' works are distributed through kiosk systems, mobile phones, movie theaters, IPTV and cable TV (10).

The “B” list (6) consists of new artists and bands that submit their packages, hard or digital, with normally only a copyright date. These artists are usually seeking artist management, a recording agreement, potential publishing, music consulting and/or traditional distribution. Interns working for Titan Global Entertainment will evaluate the submissions and if they feel that the artist has potential they will recommend that a letter of introduction be sent to the artist from Titan Global Entertainment. This letter advises the artist or band of the services which Titan Global Entertainment has to offer them. Should they decide to accept an offer from Titan Global Entertainment they will be placed in a development program and the Artist and Repertoire department of Titan Global Entertainment will assist in their development. These artists' works are distributed through the Titan Tunes website, media devices, desktop and laptop computers, personal computers, mobile phones and special venue kiosks (12).

The “C” list consists of new artists and bands which are normally only seeking digital recording contracts. These contracts enable the artists and bands to offer their music in a digital format, which is normally downloaded by the customer from a web site. The website would be Titan Tunes which is operated by Titan Global Entertainment. For example, the music may be downloadable in a digital format and a Compact Disc of their music may be purchased at the same website.

A large majority of the “C” list material is submitted in digital form through the Titan web site. Interns working for Titan Global Entertainment will evaluate the submissions and if they feel that the artist has potential they will recommend that a letter of introduction be sent to the artist from Titan Global Entertainment. The submissions which have been identified as having potential are then sent to the Music Division and Legal department for a potential contract. Any submissions that the Music division determines have potential for distribution are identified and offered a contract with a traditional Indie label or associate label. Their submissions are then stored on a server from which they can be downloaded onto devices capable of storing and playing digital media. These artists' works are distributed over a network, such as the Internet, through the Titan Tunes website, to personal desktop and laptop computers, media devices and mobile phones (14).

An example of how this could work is as follows. An artist or band sends a three song demo submission to Titan for review. For an additional professional Artist & Repertoire review fee their package receives an expedited review and professional feedback. In addition, they are entered into various contests with the opportunity to win various prizes.

Another method of attracting new talent could be a digital Battle of the Bands on the Titan Tunes web site. These would be a submission page for digital entries, a message page and voting ability to select a winner. These contests would be held on a local artist and band basis. Addition contests could be held at regional and national levels. Music video submissions could also be considered.

Another source of new artists and bands is through the College Mentorship Program (16) of Titan Global Entertainment. This program is similar to the college intern program that many record labels currently have. The individuals working in the mentorship program are students in select colleges and universities. These schools were selected because of their strong music industry related curriculum. These college students are in touch with the new bands as they are forming and are in contact with the young people who help define the new music and new trends. The mentorship program involves the college students in promoting, selling, and working in an Artist & Repertoire function while being trained in various areas of the music industry. These students by establishing connections through local college radio, local nightclubs and concert venues are taught how to introduce Titan Global Entertainment artists into the college mainstream.

The Mentorship program also enables the student to receive credits towards their degrees. Each of the select schools also offer independent study programs. Titan will recruit a select number of students to participate in these independent study programs. Titan will train the students to introduce Titan Global Entertainment artists into the college mainstream by establishing connections to local college radio stations, connections at local night clubs which spin discs from new artists and setting up listening parties to introduce Titan's current roster of artists. Titan will also train the students to identify local talent through local college radio, local promoters, and concert venues. Utilizing this program, new artists affiliated with Titan Global Entertainment will receive exposure to the most highly demographic buying public in mainstream music today.

The students receive compensation for their time and effort by receiving training in all facets of the music business. They also receive college credits toward their degrees. They gain valuable real world experience in the extremely competitive music industry.

Additional sources for discovery of new talent are websites such as Tonos Pro, MP3.com, Garage Band.com, My Space, Indie Heaven, etc. Also new artist and bands may have their own web pages. These artists' works could be distributed through Titan Tunes, media devices, desktop/laptop computers, mobile phones, and specific venue kiosk systems. These are kiosks which would be setup at concerts, for example, and the music of only the artists and bands performing at the concert would be available through these kiosks. If the artists have other related merchandise to sell, Titan would also handle also.

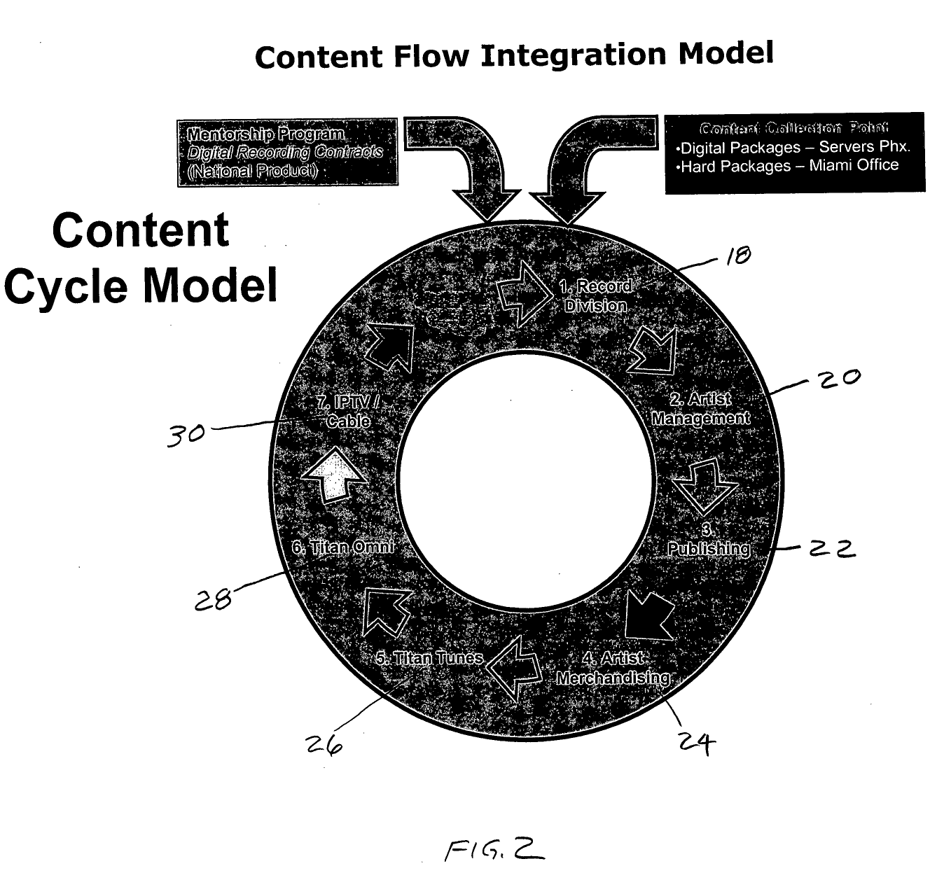

All submissions received are sent to the Record Division (18) for evaluation, as illustrated in FIG. 2. Artists or bands which are eligible and interested in artist management move onto the Artist Management division (20). Here they are pre-screened and introduced to the Artist & Repertoire department for further development.

Artists, bands, and songwriters seeking publication are directed to the Publishing division (22) where their works can be published.

Artists and bands which have signed contracts with Titan Global Entertainment become affiliated with the Artist Merchandising division (24). This division handles the marketing aspect of the artists and bands. Advertising and sale of merchandise related to the artists and bands are handled by this division. For example, clothing, memorabilia and other items associated with the artists and the bands.

The Titan Tunes division (26) includes the Titan Tunes web portal through which the majority of the consumers can contact Titan Global Entertainment and each other. The vast majority of the “C” list artists and bands currently utilize the Internet to distribute their music and contact each other. Their music is in a digital format so that it can be easily sent over the Internet and other networks. This format also enables the average person with a digital player, such as a computer or an MP3 device, to quickly and easily download music. After the music has been downloaded the individuals can move it to any convenient device for replay. Video, movies, and other streaming content can be downloaded from and/or submitted to the Titan Tunes web portal. Consumers will be able to purchase music, music videos or ring tones online through the Titan Tunes web portal. The music from the “B” and “C” list artists and bands are also developed into music for video games, ring tones and tunes for mobile phones, music for movies and television, and other specialty content.

A proprietary device which enables a user to readily interact with the Titan Tunes web site is the Titan Omni. This is a digital device which is capable of communicating over the Internet. It has a screen for display of images. It also has storage and playback features for music, video, and streaming media. Inputs on the Omni are provided for connection to microphones and other audio and video sources. The information stored on the Omni may be uploaded to the Titan Tunes web site via a hard wired connection or wirelessly. Also, music and other data may be downloaded onto the Omni from the Titan Tunes web site via a hard wired connection or wirelessly. In addition to audio and video recording and playback functions the Omni has a still camera function, an Instant Messaging function, a VoIP (voice over the internet) function and a MP3 function. The Titan Omni operation is under control of the Titan Omni division (28) of Titan Global Entertainment.

Other devices may be connected to the Omni such as headphones, a docking station and a DVR. The docking station would enable the Omni to interact with a computer or a television. This manner of operation would permit the Omni to function as an entertainment center downloading various forms of entertainment from the Titan Tunes web site and other sources. The Omni could also be wirelessly connected to these devices.

Utilizing the WiFi function of the Omni the user can download music at concert venues if the artists are connected with Titan Global Entertainment and Titan Tunes provides the wireless broadcast. All Omni devices can be registered with Titan Global Entertainment so that Titan Tunes will recognize the device and the user does not have to logon to the Titan Tunes Web site to receive the music.

The still and video camera features of the Omni would enable the user to record an event and transmit it to another location via the Titan Tunes web site or wirelessly. For example, a paramedic or rescue worker at the scene of an accident could photograph the injured individual and transmit the images to a hospital where specialists would be able to advise the paramedic what to do until the injured individual is transported to a hospital. In addition it can also offer streaming video of events at night clubs, sporting events, traffic on highways, etc.

The Omni could also be equipped with a Global Positioning Device enabling it to function as a navigation device and/or location device. With these features the Omni could replace the entertainment systems of most automobiles and also provide a navigation function.

Another division of Titan Global Entertainment controls the operation of Internet Protocol Television (IPTV) and cable television (30). Material which is available through an affiliated cable TV company is also made available for viewing on a plurality of different devices such as IPTV, set top boxes for conventional televisions, mobile phones, etc. The material could include music videos, pay per view and video on demand movies, shows and events, television shows, movies, live concerts and sporting events.

In addition to the Titan Tunes web site there can be additional points of distribution. These would be located in conventional retail establishments such as record stores and other stores which sell music and entertainment products. Non-Titan Tune members or non-Titan Omni owners would be offered the ability to purchase a Titan Tunes membership and/or a Titan Omni in a retail store so they download the latest music releases at these points of distribution. A special one time membership card is available for those individuals who want to make a one time purchase only. The advantage of the memberships is that they entitle the member to a number of free downloads depending on the level of member ship. For example a Silver membership would receive 5 music and 1 video downloads. A Gold membership would receive 8 music and 2 video downloads. A Platinum membership would receive 10 music, 5 video and one ring tone downloads.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are hot intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An interactive computer assisted method of receiving, analyzing, and distributing digital media comprising the steps of:
Providing a database means constructed and arranged to receive digital media from artists;
Means for reviewing said digital media and categorizing said digital media into artist management groups, said artist management groups consisting of professional, new artist and independent artists;
communicating said categorizing results and selected artist management groups to said artists;
means for selecting preferred artists from a predefined criteria list;
means for providing artist management from said selected artist management group to said preferred artists, said artist management providing training and promotional support to said preferred artists;
means for selecting from said trained and promoted preferred artists; and
distribution means for distributing said digital media from said preferred artists.

2. The interactive computer assisted method of claim 1 wherein said digital media is received as a digital upload or a hard package.

3. The interactive computer assisted method of claim 1 further providing a mentorship program whereby a group of individuals are selected and provided with training and experience in the music industry.

4. The interactive computer assisted method of claim 3 wherein the participants in said mentorship program identify new talent and assist in the development of said new talent.

5. The interactive computer assisted method of claim 1 further providing for the promotion and sale of artists' merchandise.

6. The interactive computer assisted method of claim 1 wherein said distributing of said digital media from said database to said authorized individuals occurs over the Internet.

7. The interactive computer assisted method of claim 1 wherein said distributing of said digital media from said database to said authorized individuals occurs wirelessly.

8. The interactive computer assisted method of claim 6 wherein said digital media is distributed to digital media devices.

9. The interactive computer assisted method of claim 6 wherein said digital media is distributed to personal computers.

10. The interactive computer assisted method of claim 7 wherein said digital media is distributed to mobile phones.

11. The interactive computer assisted method of claim 1 further providing development of said digital media into music for video games, ring tones, ting tunes, movies, or television.

12. A system for distributing digital media comprising:
means for providing a database, said database being constructed and arranged to receive digital media;
means for providing a record division for reviewing said digital media;
means for categorizing said digital media into separate artist management groups;
means for providing artist management whereby selected artists are provided with training and promotion;
means for providing a publishing division whereby a portion said selected artists are provided with a means to distribute their works;
means for distributing said digital media from said database to authorized individuals.

13. The system of distributing digital media of claim 12 wherein said digital media is received as a digital upload or a hard package.

14. The system of distributing digital media of claim 12 wherein said artist management groups comprise professional artists, independent artists and independent musicians.

15. The system of distributing digital media of claim 12 further including means for providing a mentorship program whereby a group of individuals are selected and provided with training and experience in the music industry.

16. The system of distributing digital media of claim 15 wherein the participants in said mentorship program identify new talent and assist in the development of said new talent.

17. The system of distributing digital media of claim 12 further including means for providing for the promotion and sale of artists' merchandise.

18. The system of distributing digital media of claim 12 wherein said means for distributing said digital media from said database to said authorized individuals comprises the Internet.

19. The system of distributing digital media of claim 12 wherein said means for distributing said digital media from said database to said authorized individuals occurs wirelessly.

20. A computer-readable medium storing computer executable process steps for distributing digital media, the process steps comprising:
providing a database, said database being constructed and arranged to receive digital media;
providing a record division for reviewing said digital media;
categorizing said digital media into separate artist management groups;
providing artist management whereby selected artists are provided with training and promotion;
providing a publishing division whereby a portion said selected artists are provided with a means to distribute their works;
distributing said digital media from said database to authorized individuals.
